(19) United States
(12) Patent Application Publication
(10) Pub. No.: US 2010/0070129 A1
(43) Pub. Date: Mar. 18, 2010

(54) VEHICLE DATA RECORDER

(75) Inventor: Andrew T. Yule, East Grinstead (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/517,572

(22) PCT Filed: Dec. 3, 2007
(86) PCT No.: PCT/IB2007/054891

§ 371 Date: Jun. 4, 2009

(30) Foreign Application Priority Data
Dec. 4, 2006 (EP) 06125364.7

(51) Int. Cl. G06F 7/00; G01S 19/14

(52) U.S. Cl. 701/33; 342/357.07; 701/35

(57) ABSTRACT

A vehicle data recorder comprises a front end RF receiver and a memory device for storing sampled satellite positioning signal data from the 5 front end receiver. The memory device stores a block of sampled data corresponding to a time period leading up to the time of an incident involving the vehicle. The data can be stored with a low cost system, and can be analysed after the incident by a remote data processing station.

This invention relates to a vehicle data recorder, for example for use in analysing the circumstances leading up to an accident.

The most well known device of this type is the aircraft black box, which records all available system information during flight.

It has been proposed to adopt a similar approach for road vehicles, with the system recoding such information as ABS activation data, electronic control management information, brake pedal activation information etc., to assist in deriving the causes of an accident.

It has also been proposed to use a GPS receiver to enable speed, and position calculations to be performed, and time measurements to be obtained. This information can then be stored with other internal vehicle system information.

The use of a GPS receiver to provide speed and position information to supplement the other control system information adds significantly to the cost of the system.

A GPS receiver comprises a radio receiver which receives signals from typically four or more GPS satellites. Equations are used by the GPS receiver to derive the coordinates of the receiver, as well as a clock bias from a knowledge of the satellite positions and their respective pseudoranges. The velocity of the receiver can be obtained from a knowledge of the satellite velocities and their respective Doppler shifts as measured by the receiver.

The data transmitted by each satellite consists broadly of three sets of information, the ephemeris, the almanac and the clock correction parameters. The ephemeris consists of detailed information about the satellite's own course over the next few hours, the almanac consists of less detailed information about the complete satellite constellation for a longer period and the clock correction parameters allow the user to correct for the GPS satellite's own clock errors. The satellite transmissions consist of a direct sequence spread spectrum (DSSS) signal containing the ephemeris, almanac, and the clock correction information at a rate of 50 bits per second (bps). In the case of the standard positioning service (SPS) a pseudo random noise (PRN) signal which has a chip rate of 1.023 MHz and which is unique to each satellite is used to spread the spectrum of the information, which is then transmitted on a centre frequency of 1575.42 MHz. The PRN signal is known as a coarse/acquisition (C/A) code since it provides the timing marks required for fast acquisition of GPS signals and coarse navigation.

To recover the GPS data and measure the propagation time of the satellite signals, the GPS receiver must cancel or allow for the Doppler frequency offset and generate the C/A code relevant to each satellite.

This can be very computationally intense, as to de-spread the DSSS signals, the incoming and locally generated PRN codes must be exactly at synchronism.

The processing power required to process a received GPS signal is therefore significant, and the resulting cost of a vehicle black box using a GPS receiver may therefore be prohibitive, particularly if the black box GPS system is to be independent of any GPS navigation system of the vehicle. This may be desirable so that additional security measures can be taken for the black box GPS system to avoid falsification of data.

According to the invention, there is provided a vehicle data recorder, comprising:

a front end RF receiver for receiving satellite positioning signal data;

a memory device for storing sampled satellite positioning signal data from the front end receiver; and

means for controlling the memory device to store a block of sampled satellite positioning signal data corresponding to a time period leading up to the time of an incident involving the vehicle.

This system enables the data required to analyse a vehicle position leading up to an incident to be stored, without needing the satellite signal data processing capability. The data recorder also does not require any transmission capability. This enables a low cost system to be implemented.

The system may be a GPS system, in which the satellite positioning signals are GPS data. The GPS data will include the GPS ephemeris, almanac and clock correction data, and before any computationally intensive digital signal processing, such as correlation calculations. The GPS data is in the form of a digitised IF signal.

The memory device is preferably adapted by the controlling means to operate with a circular first in first out function. In this way, the set of data leading up to an incident is stored. This may be at least 5 minutes of data, 10 minutes, 1 hour or more. The memory device preferably stores the data as samples of the digitised and frequency downconverted received RF signals.

A detector is preferably provided for detecting the incident, to cease any subsequent replacement of memory data. An airbag actuation signal may be used for this purpose, or an accelerometer and/or emergency button.

The memory device may be controlled to operate with a circular first in first out function only when a vehicle ignition is turned on.

In one embodiment, a plurality of antennae is provided, and the memory device is adapted to store sampled data from each of the antennae.

The invention also provides a vehicle data recorder system, comprising:

a vehicle data recorder of the invention; and

a processing system for processing the sampled data from the memory device to derive historical speed and position information.

The processing system enables processing to be carried out using the most up to date processing techniques, and without requiring any processing power in the data recorder in the vehicle. The system may comprise a plurality of vehicle data recorders, and the processing system is then adapted to process together the sampled data from the memory devices of a plurality of vehicle data recorders to derive historical speed and position information. This improves the accuracy of the relative position information obtained.

The processing system preferably comprises a memory device for storing historical satellite positioning information to enable the processing of the historical sampled satellite positioning signal data.

The invention also provides a method of analysing vehicle data concerning a vehicle involved in an incident, comprising:

in advance of the incident, storing sampled satellite positioning signal data form an RF front end receiver provided on board the vehicle into a memory device on board the vehicle; and

after the incident, processing the sampled satellite positioning signal data from the memory device at a processing site remote from the vehicle to derive historical speed and position information.

The present invention will now be described, by way of example only, with reference to the accompanying schematic drawings in which:

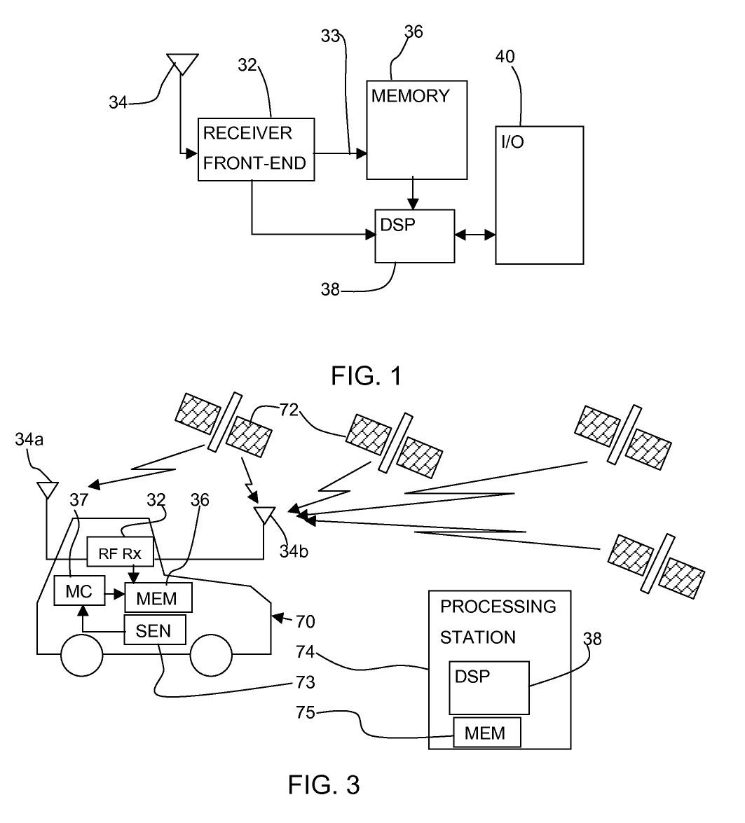

FIG. 1 shows a conventional GPS receiver architecture in schematic form;

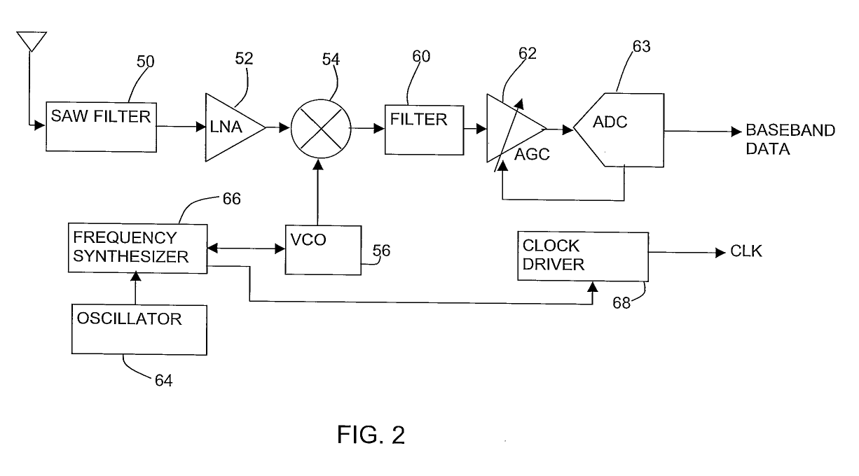

FIG. 2 shows an example of the front end receiver in greater detail; and

FIG. 3 shows a vehicle data recorder and processing station of the invention.

The invention is of particular interest for so-called “software GPS”, namely a GPS system in which all the data processing is implemented in software, with the received data stored in a memory buffer. This enables the real time link of the receiver to be broken, and reduces the amount of dedicated hardware required (such as correlators).

The basic architecture of a software GPS receiver 30 is represented in FIG. 1.

The receiver comprises a receiver front-end 32, which receives the wireless signals using an antenna 34. The receiver front-end 32 receives modulated RF signals from one or more satellites.

The received signal is amplified, filtered, down-converted, and digitized by the receiver front-end 32 to produce a baseband signal 33 derived from the received signal, and in the form of digitised samples of the down-converted GPS data.

The digitised samples are provided to a memory buffer 36, and the data stored in the memory 36 is processed by a general purpose CPU i.e. a digital signal processor (DSP) 38. A user interface is provided by input/output system 40. The digitised samples are processed to extract the information and data from the satellite signals. The data samples are typically in the form of one or two bit data, and at a much higher analogue to digital sampling rate than the data rate of the signals received from the satellites.

The DSP 38 implements the functions of more conventional dedicated hardware systems, of correlation, multiplexing and Fourier transformations, in known manner.

FIG. 2 shows one example of front-end receiver 32 in greater detail, so that the signals present in the receiver can be explained.

The signals received from the antenna are filtered by a surface acoustic wave (SAW) filter 50 before amplification by a low noise amplifier (LNA) 52. The signals are mixed at mixer 54 with the output of a voltage controlled oscillator (VCO) 56. This down-converts the signals to an intermediate frequency baseband, where they are subjected to further filtering by filter 60 and amplification with automatic gain control (AGC) in the amplifier 62. Analogue to digital conversion takes place in converter 63, which also provides a feedback control for the AGC setting. The front-end receiver also includes an oscillator 64 and frequency synthesizer 66 as shown, with the frequency synthesiser controlling a clock driver 68 to generate a clock signal CLK.

The invention uses the front end receiver and memory device alone as a data recorder, with the memory functioning as a circular first in first out memory. In this way, the memory can store the required GPS data to analyse the events leading up to an accident, but the data recorder does not need the processing power to interpret the data.

The system of the invention is shown in FIG. 3.

As shown, a vehicle 70 is provided with a data recorder, which comprises only the GPS front end RF receiver 32 and the memory device 36 for storing the baseband GPS data from the front end receiver. The memory device 36 is a circular first in first out memory, so that it stores a block of the most recent GPS data. A memory controller 37 provides the required memory control. The GPS satellites are shown as 72.

The data recording device is connected to the electronics of the rest of the vehicle so that data is only recorded when the ignition is turned on (for example). The data recording is stopped when an incident is detected, and this may be based on detection of airbag deployment, although other detectors could be used, such as an accelerometer or other sensor to detect an incident rather than the airbag deployment. The driver may also have an emergency button for implementing a memory lock to retain the recent memory data,

These possibilities are all represented by the schematic sensor 73 shown in FIG. 3.

The exact form of the memory device will depend on what memory devices are available. Obviously the larger the RAM, the longer the time period which can be stored by the device. At the limit, if a sufficiently cheap technology becomes available, the entire history of the car could be recorded. This would avoid the need to operate in the memory as a circular buffer.

The antenna is mounted with a good view of the sky. FIG. 3 shows two antennae 34a, 34b, each giving separate recordings to provide extra information, such as car orientation, and/or to provide redundancy.

A third antenna would enable the full 3D orientation to be determined, including vehicle inversion.

The basic idea is thus to implement a data storage device that comprises an antenna, RF front-end and memory, capable of recording GPS data in the form of sampled intermediate frequency signals (i.e. a sampled frequency down-conversion of the original transmissions). These recordings are not processed any further until an incident occurred at which point the data recorded at and just before the incident can be extracted and processed in order to determine the position/velocity of the vehicle in which the device was installed.

A processing station is shown as 74, which includes the required processor 38 to derive the historical position and speed information.

Typically, more than one vehicle is involved in an incident, and if the multiple vehicles are fitted with such a device, the data from each vehicle can be processed together to provide more accurate relative position/velocity information than would normally be possible using such techniques as differential-GPS and/or carrier phase tracking.

Thus, the processing of the GPS data from multiple vehicles in parallel would be more accurate than simply providing a conventional GPS receiver in each vehicle, and it would be more difficult to tamper with the data.

The data recording device will have a reduced cost compared to a full GPS receiver.

Furthermore, as processing techniques evolve, these can be used when processing the data, as the data recorder function only to record the RF data (after frequency down-conversion and sampling). The processes implemented in the processing station 74 can be upgraded to use the latest sophisticated approaches, with no limit on the amount of processing power that could be deployed. Thus, more reliable results may be obtained over time, without the need to upgrade the receiver in each vehicle.

The interpretation of the data in the processing station 74 may also take into account human data input to help with difficult cases, for example where limited GPS data was available (for example as a result of a bad view of the sky).

In order to process the data, the memory 36 is preferably physically removed from the vehicle, so that in the case of an incident, the memory part of the device (at least) is recovered and made available to the post-processing organisation. This would obviously be easier if a simple “plug-in” interface is provided on the device, but given that the vast majority of devices will never need to be post-processed, there are arguments for needing specialist equipment to extract the recorded data.

There would need to be one or more organisations to provide the service of post-processing the data, providing the station 74. Such organisations would need to record and store important GPS related info such as space vehicle (SV) Ephemerides and SV clock corrections for all SVs and times of interest. A memory for this purpose is shown as 75. SV Health information and data on atmospheric effects would also be desired, such as the transmitted ionospheric data, in order to facilitate such post-processing. Raw data messages (for example 50 bps) from the SVs can also be stored.

The invention is of particular interest for domestic car use, in connection with road traffic accidents. It would be equally applicable to other vehicles (including planes), as well as other incidents, for example for asset tracking after an incident has occurred. Indeed, the device may be able to use a navigation system that is not in operation at the time of installation, as all the post-processing is done off-line after any incident.

Only one example of front end receiver design has been described above, but there are many possible variations. The invention essentially stores the data received from satellites without significant signal processing, for example only after frequency downconversion (to an intermediate frequency) and sampling. The term “satellite positioning signal data” and “GPS data” used in the description and claims will thus be understood to comprise the satellite data transmitted for the purposes of enabling position calculations to be made, and not the position or speed information derived from processing the satellite data.

The detailed description above relates to a GPS implementation, but the invention is of course applicable to any satellite based positioning system, for example the proposed Galileo satellite navigation system.

From a reading of the present disclosure, other modifications will be apparent to the skilled person and may involve other features which are already known in the design, manufacture and use of GPS or other satellite signal receivers and component parts thereof and which may be used instead of or in addition to features already described herein.

1. A vehicle data recorder, comprising:
a front end RF receiver for receiving satellite positioning signal data;
a memory device for storing sampled satellite positioning signal data from, the front end receiver); and
means for controlling the memory device to store a block of sampled satellite positioning signal data corresponding to a time period leading up to the time of an incident involving the vehicle.

2. A vehicle data recorder as claimed in claim 1, wherein the satellite positioning signal data comprises GPS data.

3. A vehicle data recorder as claimed in claim 1, wherein the memory device is adapted by the controlling means to operate with a circular first in first out function.

4. A vehicle data recorder as claimed in claim 1, wherein the memory device is adapted to store samples of the frequency down-converted received RF signals.

5. A vehicle data recorder as claimed in claim 1, further comprising a detector for detecting the incident and cease any subsequent replacement of memory data.

6. A vehicle data recorder as claimed in claim 5, wherein the detector is for receiving an airbag actuation signal.

7. A vehicle data recorder as claimed in claim 5, wherein the detector comprises an accelerometer and/or emergency button.

8. A vehicle data recorder as claimed in claim 1 wherein the memory device is adapted by the controlling means to operate with a circular first in first out function only when a vehicle ignition is turned on.

9. A vehicle data recorder as claimed in claim 1, comprising a plurality of antennae, and wherein the memory device is adapted to store sampled satellite positioning signal data from each of the antennae.

10. A vehicle data recorder system, comprising:
a vehicle data recorder as claimed in claim 1; and
a processing system for processing the sampled satellite positioning signal data from the memory device to derive historical speed and position information.

11. A system as claimed in claim 10, comprising a plurality of vehicle data recorders each as claimed claim 1,
wherein the processing system is adapted to process together the sampled data from the memory devices of a plurality of vehicle data recorders to derive historical speed and position information.

12. A system as claimed in claim 10, wherein the processing system comprises a memory device for storing historical satellite positioning information to enable the processing of the historical sampled satellite positioning signal data.

13. A method of analysing vehicle data concerning a vehicle involved in an incident, comprising:
in advance of the incident, storing sampled satellite positioning signal data form an RF front end receiver provided on board the vehicle into a memory device on board the vehicle; and
after the incident, processing the sampled satellite positioning signal data from the memory device at a processing site remote from the vehicle to derive historical speed and position information.

14. A method as claimed in claim 13, wherein processing the sampled satellite positioning signal data comprises processing together the sampled satellite positioning signal data from the memory devices of a plurality of vehicles.

15. A method as claimed in claim 13, wherein processing the sampled satellite positioning signal data comprises using stored historical satellite positioning information to enable the processing of the historical sampled satellite positioning signal data.
